(19) United States
(12) Patent Application Publication
(10) Pub. No.: US 2005/0046195 A1
(43) Pub. Date: Mar. 3, 2005

(54) Motor vehicle with wind generator device

(76) Inventor: Theodore P. Kousoulis, Hunterdon, NJ (US)

Correspondence Address: Kenneth P. Glynn, Esq.;Glynn & Associates, P.C., 24 Mine Street, Flemington, NJ, 08822, US

(21) Appl. No.: 10/650,888

(22) Filed: Aug. 28, 2003

(51) Int. Cl. F03D 9/00; H02P 9/04

(52) U.S. Cl. 290/44

(57) ABSTRACT

The present invention relates to an enhanced, energy efficient vehicle, which may be a land vehicle, an air vehicle, and an aquatic vehicle. The vehicle includes a conventional vehicle having power means meaning that it is not hand or manually powered. The vehicle has at least one storage battery and at least one power consuming mechanism connected to the storage battery. The storage battery provides controlled delivery of electric power to the at least one power consuming mechanism. The invention further includes a supplemental power plant located on the vehicle, which includes a housing that surrounds at least one set of rotatable blades, a movable shaft connected thereto and a generator for generating electricity connected to the shaft and a voltage regulator. When the rotatable blades are moved by wind speed created by movement of the vehicle, the shaft is rapidly rotated causing the generator to impart electricity to the voltage regulator whereby the power consuming mechanism is powered by said generator so that electrical load on a storage battery is reduced. The power consuming mechanism is wired from the voltage regulator. The power means may be gasoline motor, electrical, battery motor, diesel and combinations thereof. The housing has an open front and back, and may be circular, rectangular, and triangular, and preferably pushes down to a circular shape at blades.

### BACKGROUND OF THE INVENTION

1. Field of the Invention

The present invention relates to power vehicles having a supplemental power plant that includes rotatable blades moved by the wind speed of the power vehicle to generate power for supplying electrical functions through a generator to allow power consuming devices within the power vehicle to function. The power vehicles include land vehicle vehicles, air vehicles and aquatic vehicles.

2. Information Disclosure Statement

The following patents relate to auxiliary power systems for motor vehicles:

U.S. Pat. No. 5,920,127 to Damron et al. discloses a propeller wind charging system for an electrical vehicle, which includes a multibladed small diameter propeller, which is included in an apparatus consisting of a single unenclosed propeller, an extension shaft, an armature shaft and a generator. The apparatus is to be mounted on top of an electric vehicle to transform wind energy into electrical energy for feeding such energy into the battery pack as the vehicle is being driven forward. This energy augments the stored voltage potential of the battery pack.

U.S. Pat. No. 4,394,582 to Kreissl et al. describes and illustrates a method and apparatus for utilizing the waste heat energy of an internal combustion engine in which a turbine is driven by the exhaust gases from the engine and drives an electrical generator. In order to permit a direct coupling between the turbine and the generator and to utilize completely the electrical energy recoverable from the waste heat energy, the generator is a synchronous machine with a none-wound rotor. In addition, the generator is connected via an electrical converter to an electric motor, which is drivingly coupled to the internal combustion engine to relieve the load therein.

Notwithstanding the prior art, the present invention is neither taught nor rendered obvious thereby.

### SUMMARY OF THE INVENTION

The present invention relates to enhanced, energy efficient vehicles, which may be land vehicles, air vehicles, aquatic vehicles, or the like. The vehicles include conventional land vehicles, conventional air vehicles and conventional aquatic vehicles having power means meaning that it is not hand or manually powered. The conventional vehicle has at least one storage battery and at least one power consuming mechanism connectable to the storage battery, either directly or indirectly. The power consuming mechanisms include heaters (blowers), air conditioners (compressors and blowers), radios, wipers, CD players, instruments, lighting, etc. The storage battery provides controlled delivery of electric power to the at least one power consuming mechanism.

The invention further includes a supplemental power plant located on the conventional vehicle, which includes a housing that surrounds at least one set of rotatable blades, a movable shaft connected thereto and a generator for generating electricity connected to the shaft; and a voltage regulator. When the rotatable blades are moved by wind speed created by movement of the vehicle, the shaft is rapidly rotated causing the generator to impart electricity to the voltage regulator whereby the power consuming mechanism is powered by the generator so that electrical load on a storage battery is reduced.

The at least one power consuming mechanism may be one from the group consisting of electrical, lighting, air conditioning, refrigeration, radio, vehicle computer, and combinations thereof. Furthermore, the power consuming mechanism is wired from the voltage regulator through a wire. The power means is selected from the group consisting of gasoline motor, electrical, battery, diesel motor and combinations thereof.

The housing, which has an open front and an open back, has a shape wherein the shape is any shape, such as circular, rectangular, and triangular, and preferable pushes down to a circular shape at the blades. Moreover, the housing may be shaped so as to apply the venturi force. When a radius of the housing decreases as the housing approaches the rear side, providing for faster movement of the shaft to through the generator, more power is generated. When a radius of the housing increases as the housing approaches the rear side providing for slower movement of the shaft to through the generator, less power is generated. It is preferable to use the venturi force to increase efficiency.

### BRIEF DESCRIPTION OF THE DRAWINGS

The present invention should be more fully understood when the specification herein is taken in conjunction with the drawings appended hereto wherein:

FIG. 1 shows a side view of a present invention land vehicle with wind generator device;

FIG. 2 shows a side cut view of a present invention supplemental power plant;

FIG. 3 shows a partially cut view of a power consuming mechanism connected to the supplemental power plant through a wire;

FIGS. 4 and 5 show a present invention housing for the supplemental power plant being in a shape of circular and rectangular, respectively;

FIG. 6 shows a perspective view of a present invention housing of a supplemental power plant being a Venturi tube with two openings extending into one opening;

FIG. 7 shows a side view of a present invention air vehicle with wind generator device;

FIG. 8 shows a partially cut view of a power consuming mechanism of the air vehicle of FIG. 8 connected to the supplemental power plant through a wire; and

FIG. 9 shows a side view of a present invention aquatic vehicle with wind generator device.

### DETAILED DESCRIPTION OF THE PRESENT INVENTION

The present invention relates to enhanced, energy efficient vehicles, which may be land vehicles, air vehicles, aquatic vehicles, and the like. The vehicles include conventional land vehicles, conventional air vehicles and conventional aquatic vehicles having power means meaning that it is not hand or manually powered.

The conventional vehicle has at least one storage battery and at least one power consuming mechanism connectable to the storage battery, either directly or indirectly. The power consuming mechanisms include heaters (blowers), air conditioners (compressors and blowers), radios, wipers, CD players, instruments, lighting, etc. The storage battery provides controlled delivery of electric power to the at least one power consuming mechanism.

The invention further includes a supplemental power plant located on the conventional vehicle, which includes a housing that surrounds at least one set of rotatable blades, a movable shaft connected thereto and a generator for generating electricity connected to the shaft; and a voltage regulator. When the rotatable blades are moved by wind speed created by movement of the vehicle, the shaft is rapidly rotated causing the generator to impart electricity to the voltage regulator whereby the power consuming mechanism is powered by the generator so that electrical load on a storage battery is reduced.

The at least one power consuming mechanism may be one from the group consisting of electrical, lighting, air conditioning, refrigeration, radio, vehicle computer, and combinations thereof. Furthermore, the power consuming mechanism is wired from the voltage regulator through a wire. The power means is selected from the group consisting of gasoline motor, electrical, battery, diesel motor, and combinations thereof.

The housing, which has an open front and an open back, has a shape wherein the shape is any shape such as circular, rectangular, and triangular, and preferably pushes down to a circular shape at the blades. Moreover, the housing may be shaped so as to apply the venturi force. When a radius of the housing decreases as the housing approaches the rear side providing for faster movement of the shaft to through the generator, more power is generated. When a radius of the housing increases as the housing approaches the rear side providing for slower movement of the shaft to through the generator, less power is generated. It is preferable to use the venturi effect to increase efficiency.

The general idea of the invention is to incorporate the wind turbine for production of electricity using the wind speed created by vehicles. The electricity generated can be connected to vehicle power accessories and to batteries so to charge them and eliminate the drainage on a main vehicle battery. Among the benefits are monetary in that there is a saving on fuel, environmental in that the energy is clean energy, and extending the life of conventional vehicle batteries.

The placement of the supplemental power plant is not significant for operation of the invention. The supplemental power plant may be located on any part of a vehicle, including a roof, a side, a front, a rear, and underneath the vehicle. As long as the placement does not interfere with a user's view, that location is considered within the scope of the invention.

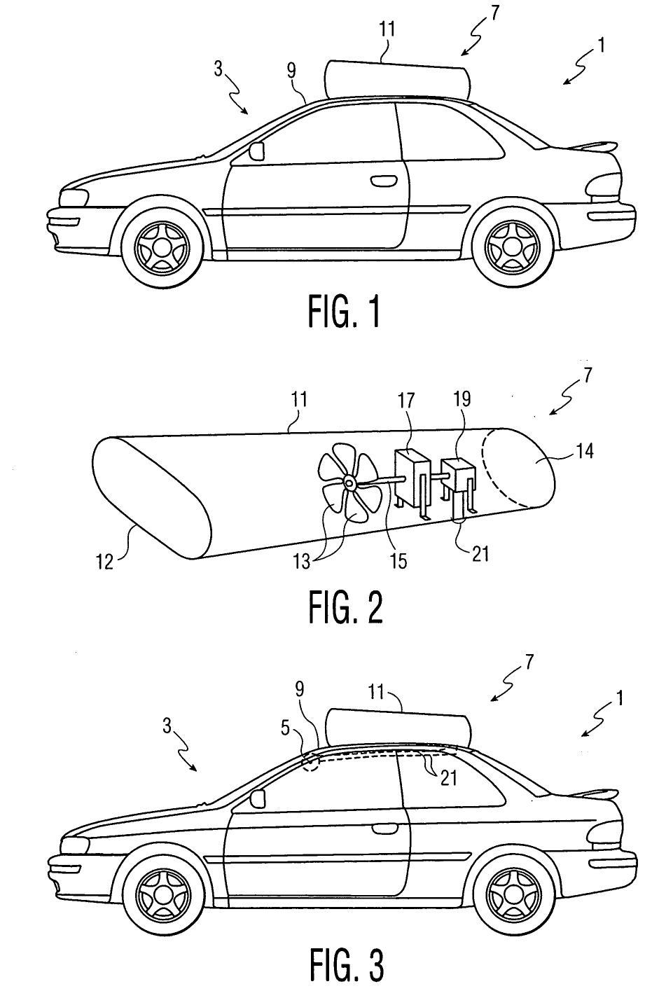

Referring now to the drawings, FIG. 1 shows a side view of a present invention land vehicle with wind generator device 1 while FIG. 2 shows a side cut view of a present invention supplemental power plant. FIG. 3 shows a partially cut view wire connection from the present invention supplemental power plant 7 to the power consuming mechanism 5.

The present invention 1 relates to enhanced, energy efficient vehicles, which, in this case is a land vehicle. Land vehicles may include cars, trucks, trains, and the like.

The vehicle 1 includes a conventional land vehicle 3, having power means meaning that it is not hand or manually powered. The conventional vehicle 3 has at least one storage battery and at least one power consuming mechanism 5, which may be connected to the storage battery, either directly or indirectly.

The invention further includes a supplemental power plant 7 located on a roof 9 of the conventional vehicle 3, which includes a housing 11 that surrounds at least one set of rotatable blades 13, a movable shaft 15 connected thereto and a generator 17 for generating electricity connected to the shaft 15 and a voltage regulator 19. When the rotatable blades 13 are moved by wind speed created by movement of the vehicle, the shaft 15 is rapidly rotated causing the generator 17 to impart electricity to the voltage regulator 19 whereby the power consuming mechanism 5 is powered by the generator 17 so that electrical load on a storage battery is reduced.

As shown in FIG. 2, the supplemental power plant 7 is designed in the form of a Venturi tube where the diameter of the tube decreases along the circumference of the supplemental power plant 7, from the front to the back, where the blades 13, generator 17 and voltage regulator 19 are located. In this way, a Venturi force of increased speed of movement of the blades 13 is acted upon in the supplemental power plant 7.

The at least one power consuming mechanism 5 may be one from the group consisting of electrical, lighting, air conditioning, refrigeration, radio, CD player, wipers, instruments, vehicle computer, and combinations thereof. Furthermore, the power consuming mechanism 5 is wired from the voltage regulator 19 through wire 21. The power means may be one of gasoline motor, electrical, battery, diesel motor and combinations thereof.

The location of the supplemental power plant is not critical, as long as it does not interfere with a driver's view. Thus, the supplemental power plant may be located on a front of the vehicle, on a side of a vehicle, underneath a vehicle, or on a rear of a vehicle.

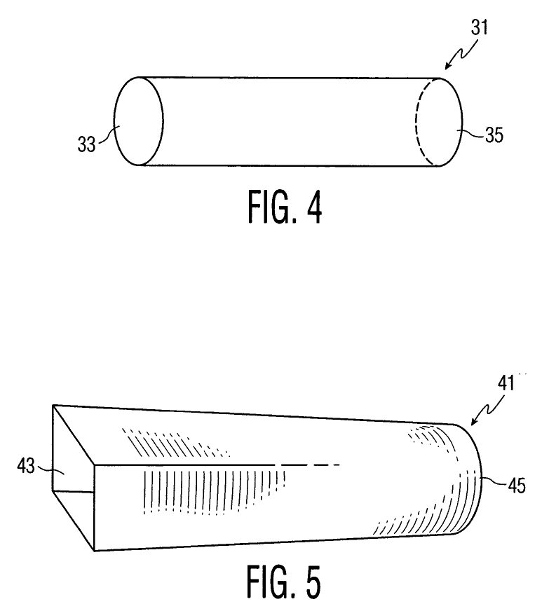

Referring now to FIGS. 4 and 5, there is shown present invention housings 31, and 41 for a supplemental power plant having a front being in a shape of circular 33 and rectangular 43, respectively. The open rears 35 and 45 are circular in shape. At the point where blades (not shown) are positioned, the shape of the housings 41 and 51 are pushed to circular.

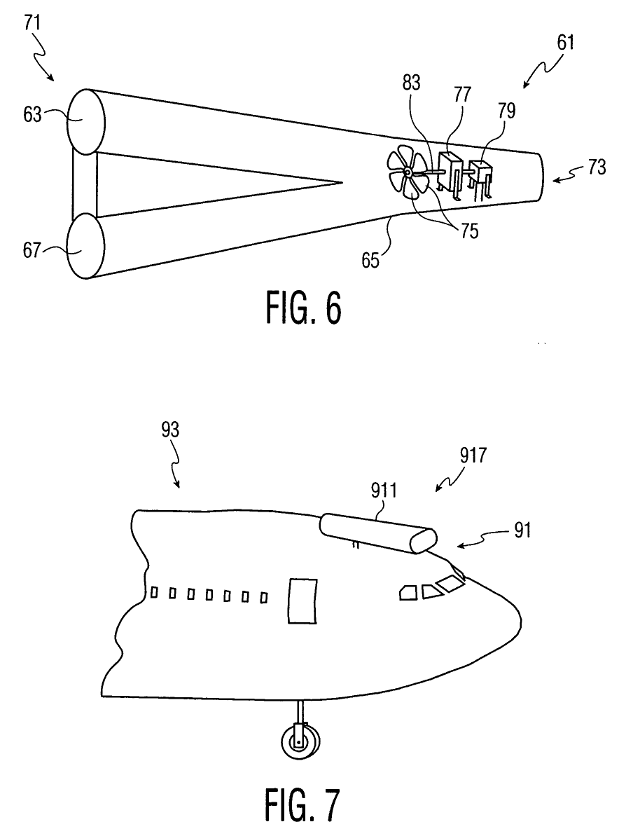

Moreover, as shown in FIG. 6, the housing 61 may be shaped so as to apply the venturi force through two tubes 63 and 67 converging into one 65. The radius of the openings of the tubes decreases as the housing goes from a wind-input end 71 to the generator end 73. Moreover, the sum of the radii decreases as the housing approaches the generator end and the sum at the generator end of the tubes 63 and 67 must be greater than or equal to the radius of the single tube 65 at any point. The generator remains as described by FIG. 2 with blades 75 mounted on a shaft 83, which shaft is rotated by the wind force against the blades 83 causing a generator 77 to impart electricity to a voltage regulator 79.

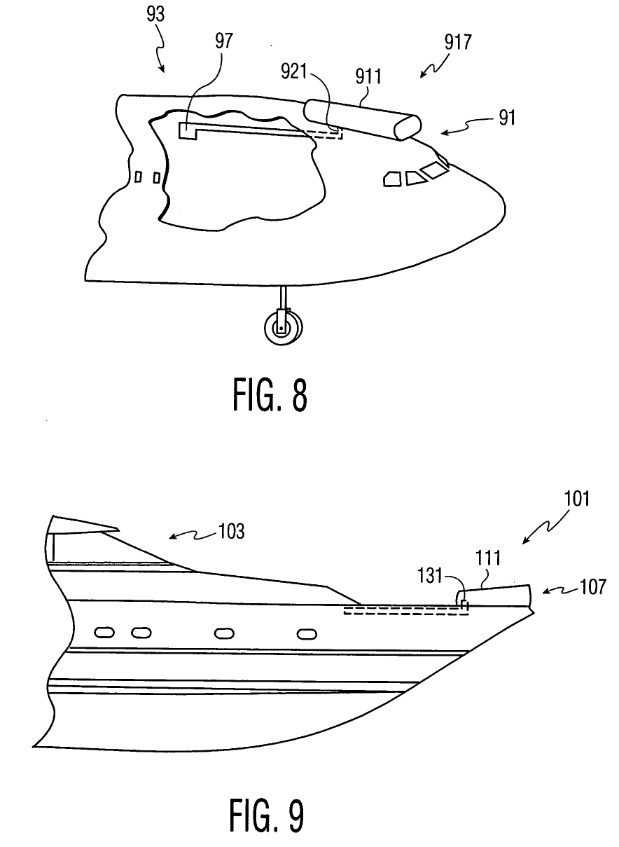

FIG. 7 shows a side view of a present invention air vehicle with wind generator device 91, while FIG. 8 shows a partially cut view of a power consuming mechanism 97, in this case cabin lighting, connected to a supplemental power plant 917 through a wire 921. The device 91 includes a conventional air vehicle 93 and the supplemental power plant 917. The supplemental power plant 917 includes a housing 911, which includes rotatable blades, a moveable shaft, a generator and a voltage regulator, as described herein above under FIGS. 1 through 3. The air vehicle 93 may include airplane, helicopter, space shuttle, and the like.

FIG. 9 shows a side view of a present invention aquatic vehicle with wind generator device 101, which includes a conventional aquatic vehicle 103 and a supplemental power plant 107. The supplemental power plant 107 includes a housing 111 and a wire 131 from the supplemental power plant 107 to a power consuming mechanism. The aquatic vehicle may be a boat, a ship, a jet ski, and the like.

Obviously, numerous modifications and variations of the present invention are possible in light of the above teachings. It is therefore understood that within the scope of the appended claims, the invention may be practiced otherwise than as specifically described herein.

1. An enhanced, energy efficient land vehicle, which comprises:
a.) a conventional land vehicle having land power means, and having at least one storage battery and at least one power consuming mechanism connectable to the storage battery, directly or indirectly, for controlled delivery of electric power to said at least one power consuming mechanism; and
a.) a supplemental power plant located on said conventional land vehicle, said supplemental power plant including a housing wherein said housing holds at least one set of rotatable blades, a movable shaft connected thereto, a generator for generating electricity connected to said shaft and a voltage regulator, and wherein said housing has an open front and an open back for permitting said shaft to rotate,
such that when said rotatable blades are moved by wind speed created by movement of said land vehicle, said shaft is rapidly rotated causing said generator to impart electricity to said voltage regulator whereby said power consuming mechanism is powered by said generator so that electrical load on said storage battery is reduced.

2. The enhanced, energy efficient land vehicle of claim 1 wherein said land vehicle is selected from the group consisting of a motor vehicle and a train.

3. The enhanced, energy efficient land vehicle of claim 2 wherein said power consuming mechanism is selected from the group consisting of electrical, lighting, air conditioning, refrigeration, radio, land vehicle computer, and combinations thereof.

4. The enhanced, energy efficient land vehicle of claim 3 wherein said power consuming mechanism is wired from said voltage regulator through a wire.

5. The enhanced, energy efficient land vehicle of claim 4 wherein said power means is selected from the group consisting of gasoline, electrical, battery, diesel and combinations thereof.

6. The enhanced, energy efficient land vehicle of claim 5 wherein a front end of said housing has a shape wherein said shape is one of circular, rectangular, and triangular.

7. The enhanced, energy efficient land vehicle of claim 6 wherein a radius of said housing decreases as said housing approaches a rear end to allow for faster movement through said generator whereby more power is generated.

8. The enhanced, energy efficient land vehicle of claim 6 wherein a radius of said housing increases as said housing approaches a rear end to allow for slower movement through said generator whereby less power is generated.

9. A enhanced, energy efficient air vehicle, which comprises:
a.) a conventional air vehicle having air power means, and having at least one storage battery and at least one power consuming mechanism connectable to said storage battery, directly or indirectly, for controlled delivery of electric power to said at least one power consuming mechanism; and
b.) a supplemental power plant located on said conventional air vehicle, said supplemental power plant including a housing wherein said housing holds at least one set of rotatable blades, a movable shaft connected thereto and a generator for generating electricity connected to said shaft and a voltage regulator, and wherein said housing has an open front and an open back for permitting said shaft to rotate,
such that when said rotatable blades are moved by wind speed created by movement of said air vehicle, said shaft is rapidly rotated causing said generator to impart electricity to said voltage regulator whereby said power consuming mechanism is powered by said generator so that electrical load on said storage battery is reduced.

10. The enhanced, energy efficient air vehicle of claim 9 wherein said land vehicle is selected from the group consisting of a helicopter, an airplane, and a space shuttle.

11. The enhanced, energy efficient air vehicle of claim 10 wherein said power consuming mechanism is selected from the group consisting of electrical, lighting, air conditioning, refrigeration, radio, CD player, instruments, air vehicle computer, and combinations thereof.

12. The enhanced energy efficient air vehicle of claim 11 wherein said power consuming mechanism is wired from said voltage regulator through a wire.

13. The enhanced, energy efficient air vehicle of claim 12 wherein said power means is selected from the group consisting of gasoline motor, electrical, battery, diesel motor and combinations thereof.

14. The enhanced, energy efficient air vehicle of claim 13 wherein a front end of said housing has a shape wherein said shape is one of circular, rectangular, and triangular.

15. The enhanced, energy efficient air vehicle of claim 14 wherein a radius of said housing decreases as said housing approaches a rear end to allow for faster movement of said shaft whereby more power is generated.

16. The enhanced, energy efficient air vehicle of claim 14 wherein a radius of said housing increases as said housing approaches a rear end to allow for slower movement of said shaft whereby less power is generated.

17. A enhanced, energy efficient aquatic vehicle, which comprises:
a.) a conventional aquatic vehicle having aquatic power means, and having at least one storage battery and at least one power consuming mechanism connectable to said storage battery, directly or indirectly, for controlled delivery of electric power to said at least one power consuming mechanism; and
b.) a supplemental power plant located on said conventional aquatic vehicle, said supplemental power plant including a housing wherein said housing holds at least one set of rotatable blades, a movable shaft connected thereto and a generator for generating electricity connected to said shaft and a voltage regulator, and wherein said housing has an open front and an open back for permitting said shaft to rotate,
such that when said rotatable blades are moved by wind speed created by movement of said aquatic vehicle, said shaft is rapidly rotated causing said generator to impart electricity to said voltage regulator whereby said power consuming mechanism is powered by said generator so that electrical load on said storage battery is reduced.

18. The enhanced, energy efficient aquatic vehicle of claim 17 wherein said aquatic vehicle is selected from the group consisting of a boat, a ship, a helicopter, and a jet ski.

19. The enhanced, energy efficient aquatic vehicle of claim 18 wherein said power consuming mechanism is selected from the group consisting of electrical, lighting, air conditioning, refrigeration, radio, CD player, instruments, air vehicle computer, and combinations thereof.

20. The enhanced, energy efficient aquatic vehicle of claim 11 wherein said power consuming mechanism is wired from said voltage regulator through a wire.
